(19) United States
(12) Patent Application Publication
(10) Pub. No.: US 2009/0114243 A1
(43) Pub. Date: May 7, 2009

(54) Plastic disposable right angle tooth cleaner

(76) Inventor: Don McNeil, Brandon, MS (US)

Correspondence Address: Don McNeil, 105 Deerfield Place, Brandon, MS, 39042, US

(21) Appl. No.: 12/228,638

(22) Filed: Aug. 15, 2008

Related U.S. Application Data
(60) Provisional application No. 60/969,928, filed on Sep. 4, 2007.

(51) Int. Cl. A61C 15/02

(52) U.S. Cl. 132/329

(57) ABSTRACT

A molded plastic toothpick device that includes a round handle with a right angle tapered tip. The cylindrical handle allows rotating the device in the finger to correctly insert the taper tip in spaces between both the upper and lower teeth.

The objective of the invention is to enable individuals to effectively clean between every tooth easier than dental floss or a straight toothpick. Also you massage the gums between each tooth. This will help keep the gums healthy. It works great in the posterior area.

There is no product on the market now that does this. The toothpick can be produced at relatively low cost from plastic.

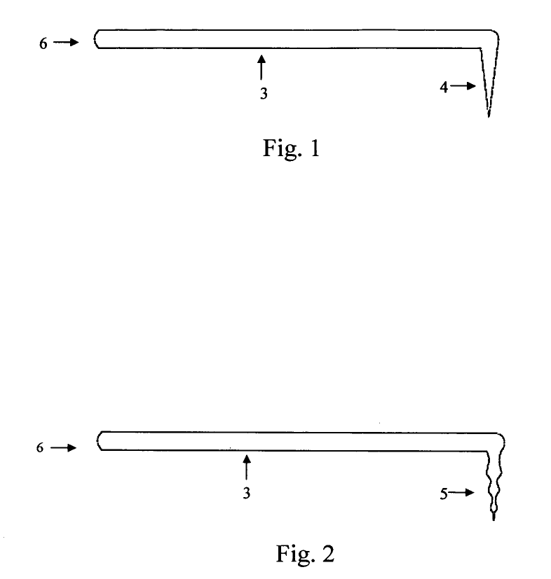

FIG. 1. A perspective view of a combined toothpick and cleaner. The back side is the same as the front side with a 90 degree round taper cylindrically shape tip or triangular tip.

FIG. 2. Is a perspective view of a combined toothpick and cleaner. The back side is the same as the front side with a 90 degree round or flat serrated tip.

### DETAILED DESCRIPTION

Number 3. FIG. 1 and FIG. 2 are the same. It's a round handle about 3 inches long and about 1/16 inch around.

Number 4. FIG. 1 is a 90 degree round taper or triangular smooth tip about ½ inch long.

Number 5. In FIG. 2 it is a 90 degree round taper or triangular serrated tip about ½ inch long.

Number 6. In FIG. 1 and FIG. 2 are the same. It's a smooth rounded end for safety purposes.

What is claimed is:

1. A right angle plastic disposalble toothpick device for removing food particals and plaque from between adjacent teeth. The right angle tip makes it much easier to clean between the posterier teeth than a straight toothpick or dental floss does where there is no space on the top of the teeth to get dental floss through the adjacent teeth. You massage back and forth between each tooth right above the gum line and the outside and inside of each tooth. Also it massages and stimulates the gums to promote circulation. The tip is flexible perpendicular which allows the tip to flex around the curved tooth surface.
